(19) United States
(12) Patent Application Publication
(10) Pub. No.: US 2020/0270031 A1
(43) Pub. Date: Aug. 27, 2020

(54) PORTABLE WATER FILLING SYSTEM FOR A RECREATIONAL VEHICLE

(71) Applicant: Mark A. Brieschke, Ida, MI (US)

(72) Inventor: Mark A. Brieschke, Ida, MI (US)

(21) Appl. No.: 16/286,681

(22) Filed: Feb. 27, 2019

(51) Int. Cl. B65D 47/12; B65D 83/00; B65D 33/16; B60P 3/36

(52) U.S. Cl. CPC B65D 47/12; B60P 3/36; B65D 33/16; B65D 83/0055

(57) ABSTRACT

A portable water filling system for a recreational vehicle is provided. The portable water filling system for a recreational vehicle includes a protective container having a first compartment and a second compartment. The first and second compartments are rotatably connected to each other. Each of the first and second compartments forms interior cavities. A first insulative element is positioned in the first compartment. The first insulative element has a first insulative cavity. A second insulative element is positioned in the second compartment. The second insulative element has a second and third insulative cavity. A pump is positioned in the first and second insulative cavities. A plurality of fluid conductive elements is positioned with the pump in the first and second insulative cavities. A bladder is positioned in the third insulative cavity. The first and second compartments are configured for rotation from a closed orientation to an open orientation.

### BACKGROUND

Recreational vehicles, commonly abbreviated simply as RV, can be a motor vehicle or trailer, which includes internal living quarters designed for accommodation. Non-limiting examples of recreational vehicles include motorhomes, campervans, caravans (also known as travel trailers and camper trailers), fifth-wheel trailers, popup campers and truck campers.

The living quarters of a typical recreational vehicle can include one or more beds, chairs, kitchen appliances and water-usage implements including showers, toilets, sinks and the like. In many instances, recreational vehicles have one or more water holding tanks configured for water storage. The water holding tanks are in fluid communication with the water-usage implements in a manner such as to supply water as needed.

Typically, the water holding tanks can have a capacity in a range of about 20 gallons to 40 gallons. In many instances the water stored in the water holding tanks can be used within a few days. As the water holding tanks are drained of the stored water, it becomes necessary to refill the water holding tanks. Typically, the refill process involves moving the recreational vehicle and connecting the water holding tanks to a water source.

It would be advantageous if the water holding tanks in a recreational vehicle could be refilled without requiring movement of the recreational vehicle.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the lubrication apparatus.

The above objects as well as other objects not specifically enumerated are achieved by a portable water filling system for a recreational vehicle. The portable water filling system for a recreational vehicle includes a protective container having a first compartment and a second compartment. The first and second compartments are rotatably connected to each other. Each of the first and second compartments forms interior cavities. A first insulative element is positioned in the first compartment. The first insulative element has a first insulative cavity. A second insulative element is positioned in the second compartment. The second insulative element has a second and third insulative cavity. A pump is positioned in the first and second insulative cavities. A plurality of fluid conductive elements is positioned with the pump in the first and second insulative cavities. A bladder is positioned in the third insulative cavity. The first and second compartments are configured for rotation from a closed orientation to an open orientation.

Various objects and advantages of the portable water filling system for a recreational vehicle will become apparent to those skilled in the art from the following detailed description, when read in light of the accompanying drawings.

### BRIEF DESCRIPTION OF THE DRAWINGS

FIG. 1 is a perspective view of a protective container shown in a closed orientation and housing a portable water filling system for a recreational vehicle.

FIG. 2 is a perspective view of the protective container of FIG. 1 shown in an open orientation and housing a portable water filling system for a recreational vehicle.

FIG. 3 is a perspective view of the protective container of FIG. 1 shown in an open orientation and further showing elements of the portable water filling system for a recreational vehicle removed from the protective container.

FIG. 4 is a perspective view of a bladder of the portable water filling system for a recreational vehicle of FIG. 3.

FIG. 5 is a cross-sectional view of the bladder of FIG. 4.

FIG. 6 is a perspective view of a bladder port and conduit of the bladder of FIG. 4.

FIG. 7 is a perspective view of a pump of the portable water filling system for a recreational vehicle of FIG. 3.

FIG. 8 is a perspective illustration of the bladder of FIG. 4 connected to a source of water.

FIG. 9 is a perspective illustration of the bladder of FIG. 4 and pump of FIG. 7 connected to a conventional recreational vehicle.

### DETAILED DESCRIPTION

The portable water filling system for a recreational vehicle will now be described with occasional reference to specific embodiments. The portable water filling system for a recreational vehicle may, however, be embodied in different forms and should not be construed as limited to the embodiments set forth herein. Rather, these embodiments are provided so that this disclosure will be thorough and complete, and will fully convey the scope of the portable water filling system for a recreational vehicle to those skilled in the art.

Unless otherwise defined, all technical and scientific terms used herein have the same meaning as commonly understood by one of ordinary skill in the art to which the portable water filling system for a recreational vehicle belongs. The terminology used in the description of the portable water filling system for a recreational vehicle is for describing particular embodiments only and is not intended to be limiting of the portable water filling system for a recreational vehicle. As used in the description of the portable water filling system for a recreational vehicle and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the portable water filling system for a recreational vehicle. Notwithstanding that the numerical ranges and parameters setting forth the broad scope of the portable water filling system for a recreational vehicle are approximations, the numerical values set forth in the specific examples are reported as precisely as possible. Any numerical values, however, inherently contain certain errors necessarily resulting from error found in their respective measurements.

The description and figures disclose a portable water filling system for a recreational vehicle (hereafter “filling system”). Generally, the filling system is configured to deliver a potable supply of water to refill water holding tanks within a recreational vehicle in a manner such that movement of the recreational vehicle is not necessary.

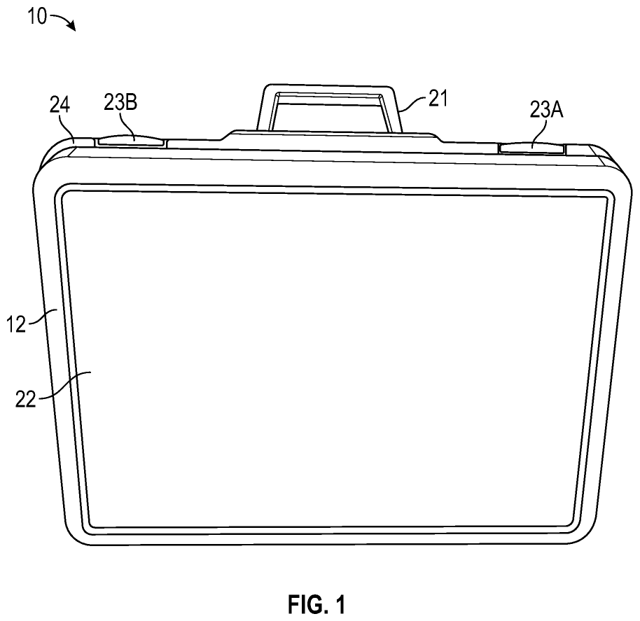

Referring now to FIGS. 1-3, a filling system is illustrated at 10. The filling system 10 is configured as a kit to provide a supply of water to a recreational vehicle without the need to move the recreational vehicle to a source of water. The term “kit”, as used herein, is defined to mean a protective container containing all of the materials and/or tools required for providing a supply of water to a recreational vehicle.

Referring again to FIGS. 1-3, the filling system 10 includes a protective container 12, a first and second insulative element 14a, 14b, a bladder 16, a pump 18 and a plurality of fluid conductive elements 20. The filling system 10, comprising the protective container 12, bladder 16, pump 18 and the plurality of fluid conductive elements 20 is ready transported from one location to another location.

Referring again to FIGS. 1-3, the protective container 12 includes a first compartment 22 and an opposing second compartment 24. The first and second compartments 22, 24 are connected together with a plurality of hinges 25a, 25b. The hinges 25a, 25b are conventional in the art and are configured to facilitate rotation of the first and second compartments 22, 24 relative to each other along an axis A-A.

Referring again to FIGS. 1-3, the first and second compartments 22, 24 are configured as a protective covering for the bladder 16, pump 18 and the plurality of fluid conductive elements 20. In use, the first and second compartments 22, 24 provide a substantially waterproof barrier against water, dirt and other deleterious effects, thereby protecting the bladder 16, pump 18 and the plurality of fluid conductive elements 20 from the elements during transportation and storage of the filling system 10.

Referring again to FIGS. 1-3, an optional handle 21 extends from the first compartment 22. The handle 21 is configured to facilitate ready movement of the filling system 10 from one location to another. However, it should be understood that the handle 21 is necessary to the operation of the filling system 10.

Referring again to FIGS. 1-3, the first compartment 22 includes a plurality of fastening mechanisms 23a, 23b configured to engage corresponding structures on the second compartment 24 in a manner such as to maintain the first and second compartments 22, 24 in a closed arrangement. In the illustrated embodiment, the fastening mechanisms 23a, 23b are clasps. Alternately, the fastening mechanisms 23a, 23b can be other structures, mechanisms and devices sufficient to engage the second compartment in a manner such as to maintain the first and second compartments 22, 24 in a closed arrangement.

Referring again to the embodiment illustrated in FIGS. 1-3, the first and second compartments 22, 24 are formed from a polymeric-based, semi-rigid material, such as the non-limiting examples of polyethylene or polypropylene. Although in other embodiments, any type of material suitable for providing a protective covering for the bladder 16, pump 18 and the plurality of fluid conductive elements 20 can be used.

Referring again to FIGS. 1-3, the first compartment 22 defines a first interior cavity 26 and in a similar manner, the second compartment 24 defines a second interior cavity 28. A first insulative element 30 is positioned within the first interior cavity 26 and a second insulative element 32 is positioned within the second interior cavity 28. The first insulative element 30 defines a first insulative cavity 34. The second insulative element 32 defines a second insulative cavity 36 that aligns with the first insulative cavity with the first and second compartments 22, 24 in a closed arrangement. The second insulative element 32 further includes a third insulative cavity 38.

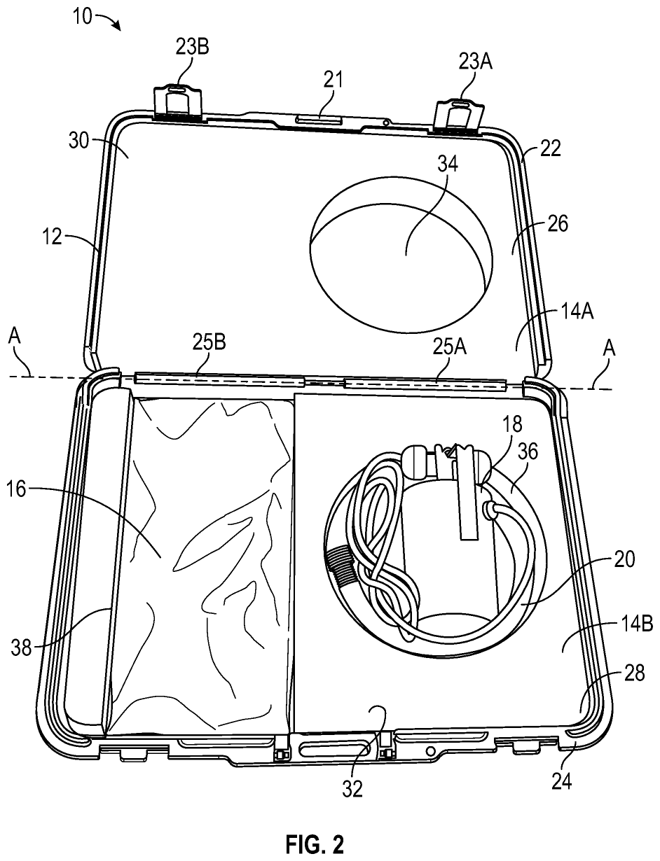

Referring now to FIG. 2, the first and second insulative cavities 34, 36 are configured to receive the pump 18 and the plurality of fluid conductive elements 20. In a similar manner, the third insulative cavity 38 is configured to receive the bladder 16 with the bladder in a folded orientation. The first and second insulative elements 30, 32 are configured to be at least slightly resilient, such that the pump 18 and the plurality of fluid conductive elements 20 can be inserted into the first and second insulative cavities 34, 36 and the bladder 16 can be inserted into the second insulative element 32 with frictional contact.

Referring again to FIG. 2, the first and second insulative elements 30, 32 are also configured to be shock absorbent, thereby protecting the bladder 16, pump 18 and plurality of fluid conductive elements 20 from impact-related damage. In the illustrated embodiment, the first and second insulative elements 32, 34 are formed from a foam polymeric-based material, such as the non-limiting examples of expanded vinyl acetate (EVA), polyethylene (EPE), polypropylene (EPP), polyurethane (EPU), co-polymer foam plastics, and foam plastics made from mixtures of plastics. However, it should be appreciated that in other embodiments, other materials can also be used, for example, paper products, such as cardboard (e.g., corrugated cardboard), foam rubber, and other materials, and combinations of materials suitable for the functions described herein.

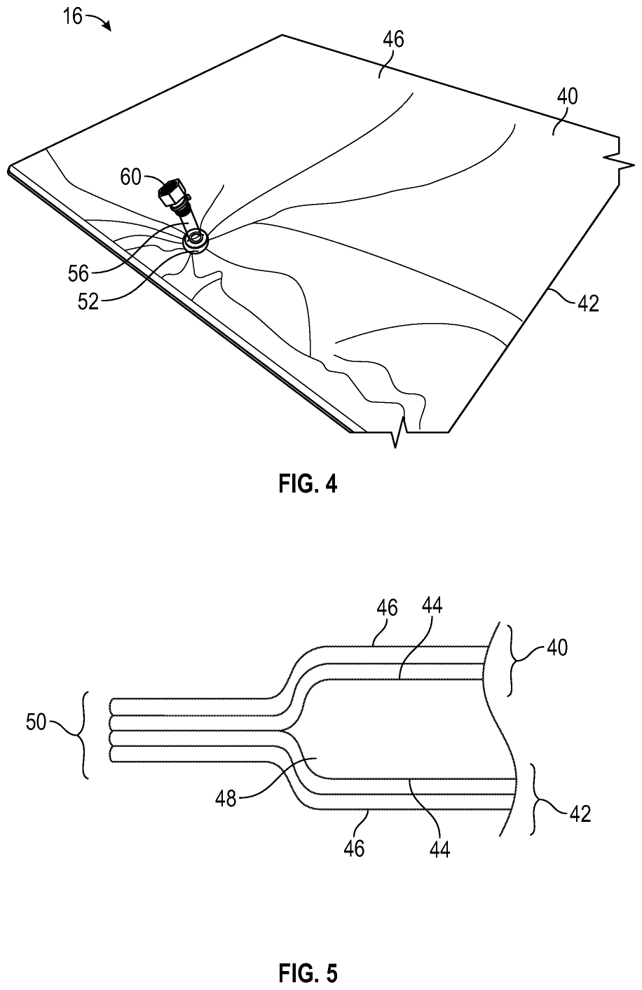

Referring now to FIG. 4, the bladder 16 is illustrated. The bladder 16 is configured for flexibility, such that the bladder 16 can have a folded arrangement, an unfilled arrangement, a partially-filled arrangement or an expanded or filled arrangement. In the folded arrangement, the bladder 16 is folded to a size sufficient for insertion into the third insulative cavity 38 in the second compartment 24. In the unfilled arrangement, the bladder 16 is devoid of any fluids contained therewithin. In the partially-filled arrangement, the bladder 16 can be filled with a volume of fluids, such as the non-limiting example of water, which is less than a bladder 16 that is fully filled with fluids. In the expanded or filled arrangements, the bladder 16 is substantially filled with fluids. In the expanded or filled arrangement, the bladder 16 has a capacity in a range of from about 20.0 gallons to about 40.0 gallons. In alternate embodiments, the bladder 16 can have a capacity less than about 20.0 gallons or greater than about 40.0 gallons.

Referring now to FIG. 5, a portion of the bladder 16 is illustrated in cross-section. The bladder 16 is formed from a top panel 40 and an opposing bottom panel 42. The top and bottom panels 40, 42 can be formed from one or more materials. Each of the top and bottom panels 40, 42 is formed from an inner layer 44 bonded to an outer layer 46. The inner layers 44 are substantially water-proof and are configured to retain fluids within a bladder cavity 48. The inner layers 44 are further configured such that the bladder cavity 48 provides potable water in compliance with NSF/ANSI 61 standard. In the illustrated embodiment, the inner layers 44 are formed from a thermoplastic polyurethane film. However, in other embodiments, the inner layers 44 can be formed from other polymeric materials, sufficient to provide a substantially water-proof cavity.

Referring now to FIG. 5, the outer layer 46 is configured to provide desired characteristics for weather resistance, hydrolysis resistance, UV stability, puncture resistance, tear resistance and low temperature flexibility. In the illustrated embodiment, the outer layer 46 is formed from a 200 denier nylon-based material. In other embodiments, the outer layer 46 can formed from other materials, combinations of materials and can also be formed as a fibrous web of non-woven fibers, such as for example, fiberglass fibers.

Referring again to FIG. 5, the materials forming the inner and outer layers 44, 46 have a hardness in a range of from about 82 to about 88, using the Shore A hardness scale, as measured by test standard ASTM D2240. The materials forming the inner and outer layers 44, 46 also have a specific gravity value of about 1.13, as measured by test standard ASTM D792. The materials forming the inner and outer layers 44, 46 further have a tensile strength in a machine direction of about 411.0 Kg/cm² as measured by test standard ASTM D412, and a tensile strength in a cross machine direction of about 408 Kg/cm² as also measured by test standard ASTM D412. The materials forming the inner and outer layers 44, 46 have an elongation in a machine direction of about 548.0% as measured by test standard ASTM D412 and an elongation in a cross machine direction of about 598.0% as also measured by test standard ASTM D412. The materials forming the inner and outer layers 44, 46 have an elongation in a machine direction of about 548.0% as measured by test standard ASTM D412 and an elongation in a cross machine direction of about 598.0% as also measured by test standard ASTM D412. The materials forming the inner and outer layers 44, 46 has a tear strength in a machine direction of about 113.0 Kg/cm as measured by test standard ASTM D624 and a tear strength in a cross machine direction of about 118.0 Kg/cm as also measured by test standard ASTM D624. The materials forming the inner and outer layers 44, 46 have a film melting point of about 140° C. Finally, the materials forming the inner and outer layers 44, 46 have a UV stability grade of about 4-5 as measured by test standard ASTM D1148.

However, it should be appreciated that in other embodiments the materials forming the inner and outer layers 44, 46 can have other values for the hardness, specific gravity, tensile strength, elongation, tear strength, film melting point and UV stability, sufficient for the functions described herein.

Referring again to FIG. 5, the top panel 40 and the bottom panel 42 are joined together at the edges of the bladder 16, thereby creating a circumferential seam 50 and the bladder cavity 48. In the illustrated embodiment, the seam 50 is formed using conventional radio frequency welding methods. In alternate embodiment, other methods and techniques, including the non-limiting example of ultra-sonic welding can be used, sufficient to create the circumferential seam 50 and the bladder cavity 48.

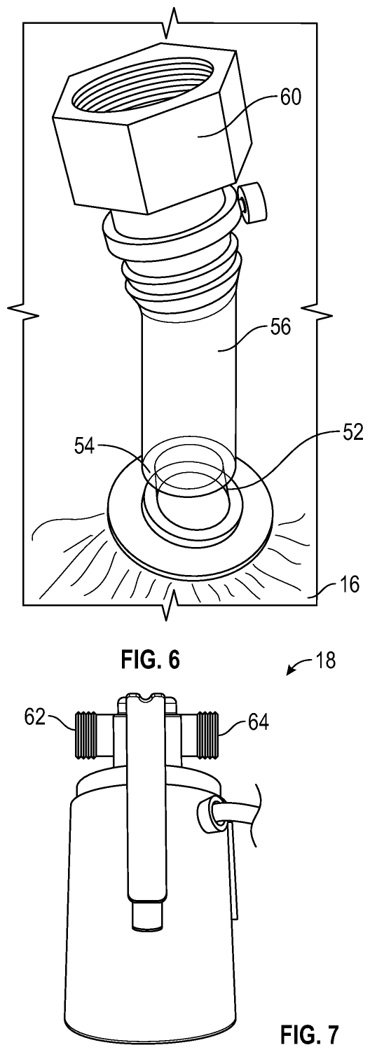

Referring now to FIGS. 4 and 6, a port 52 is formed in the bladder 16. The port 52 is in fluid communication with the bladder cavity 48. A first end 54 of a conduit 56 is in fluid communication with the port 52. The conduit 56 extends to a second end 58, which is connected to a bladder fitting 60. As will be explained in more detail below, the conduit 56, port 52 and bladder fitting 60 are configured to facilitate filling of the bladder cavity 48 with fluids, such as for example, water. In the illustrated embodiment, the conduit 56 is clear, polyvinylchloride tubing having an inner diameter of 0.75 inches. However, in other embodiments, the conduit 56 can be formed from other materials or combinations of materials and can other diameters, sufficient to facilitate filling of the bladder cavity 48 with fluids.

Referring again to FIGS. 4 and 6, the bladder fitting 60 is configured for connection to a fluid conductive element 20. In the illustrated embodiment, the bladder fitting 60 is a female end having a ¾-11.5NH threaded portion. However, in other embodiments, the bladder fitting 60 can have other structures, such as for example, a quick connection fitting, sufficient for connection to a fluid conductive element 20.

Referring now to FIG. 7, the pump 18 is illustrated. As will be described in more detail below, the pump 18 is configured for fluid connection with the bladder cavity 48, via the conduit 56, and is further configured to convey water contained in the bladder cavity 48 to an inlet port of a recreational vehicle. The pump 18 includes a pump inlet port 62 and a pump outlet port 64. The pump inlet and outlet ports 62, 64 are configured for connection to a fluid conductive element 20. In the illustrated embodiment, the pump inlet and outlet ports 62, 64 are a female end having a ¾-11.5NH threaded portion. However, in other embodiments, the pump inlet and outlet ports 62, 64 can have other structures, such as for example, a quick connection fitting, sufficient for connection to a fluid conductive element 20.

Referring again to the embodiment illustrated in FIG. 7, the pump 18 is a fractional horsepower, non-submersible, self-priming pump configured for operation on electrical power of either 115 V.A.C. or 12 V.D.C. One, non-limiting example of the pump 18 is the Little Giant Pony Pump Series Model No. 555112, manufactured and marketed by Franklin Electric Co. Inc., headquartered in Fort Wayne, Ind. However, it should be appreciated that other pumps, sufficient for the functions described herein, can be used.

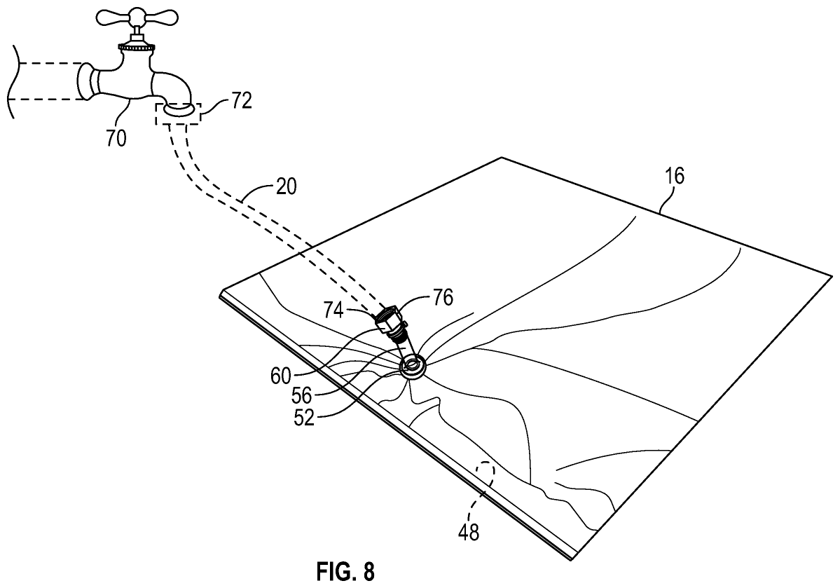

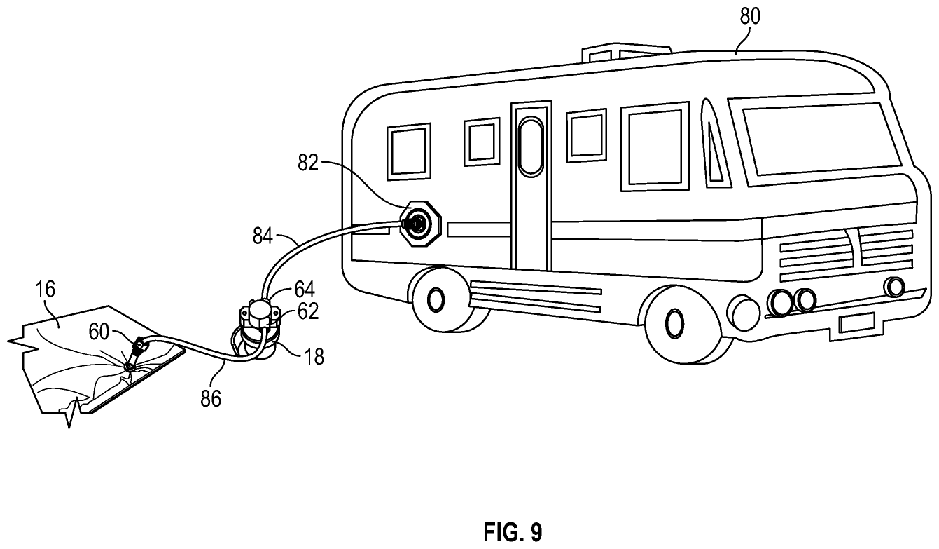

Referring now to FIGS. 8 and 9, operation of the filling system 10 will now be described. Referring first to FIG. 8, the bladder 16 is removed from the protective container 12, unfolded and placed in a flat orientation on a surface (not shown) adjacent a water source 70, such as for example a faucet. The surface can be a bed of a vehicle, dolly, table and the like. The bladder 16 is oriented on the surface in a manner such that the port 52, conduit 56 and bladder fitting 60 are accessible. A first end 72 of the fluid conductive element 20 is connected to the water source 70 and a second end 74 of the fluid conductive element 20 is connected to the bladder fitting 60. In the illustrated embodiment, the first end 72 of the fluid conductive element 20 is a female end having a ¾-11.5NH threaded portion and the second end 74 is a male end having a ¾-11.5NH threaded portion. However, in other embodiments, the first and second ends 72, 74 can have other structures, such as for example, a quick connection fitting, sufficient for connection to a water source 70 and a bladder fitting 60. Once the connections of the fluid conductive element 20 are completed, filling of the bladder cavity 48 with water can commence.

Referring again to FIG. 8, in a next step, once the bladder cavity 48 is filled with a desired volume of water, an optional cap 76 is inserted into the bladder fitting 60. The cap 76 is configured to close off the conduit 56, thereby retaining the water within the bladder cavity 48. The cap 76 can have any desired structure including a male end with a ¾-11.5NH threaded portion.

Referring now to FIG. 9, the bladder 16 containing the water within the bladder cavity 48 is transported to a location close to a conventional recreation vehicle 80. While the recreational vehicle 80 illustrated in FIG. 9 is a conventional motorhome, in other embodiments the recreational vehicle 80 can have other forms, including the non-limiting examples of campervans, caravans (also known as travel trailers and camper trailers), fifth-wheel trailers, popup campers and truck campers.

Referring again to FIG. 9, the recreational vehicle 80 includes a conventional water inlet port 82. As is conventional in the art, the water inlet port 82 is accessible from a location exterior to the recreational vehicle 80 and is configured to convey water to a holding tank (not shown) within the recreational vehicle 80. In the illustrated embodiment, the water inlet port 82 is a female fitting having a ¾-11.5NH threaded portion. However, in other embodiments, the water inlet port 82 can have other structures, such as for example, a quick connection fitting, sufficient for connection to a fluid conductive element 20.

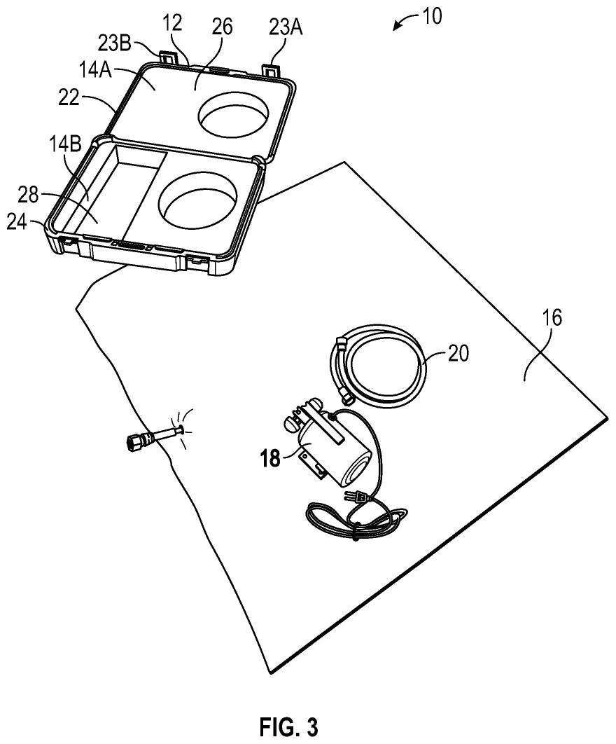

Referring again to FIG. 9, the water inlet port 82 is configured for connection to a first end of a first fluid conductive element 84. A second end of the first fluid conductive element 84 is connected to the pump outlet port 64. A second fluid conductive element 86 extends from the bladder 16 to the pump 18 with a first end of the second fluid conductive element 86 connected to the bladder fitting 60 and a second end connected to the pump inlet port 62. In the illustrated embodiment, the first and second fluid conductive elements 84, 86 are the same as, or similar to, the fluid conductive element 20 described above and illustrated in FIGS. 2 and 3. In alternate embodiments, the first and second fluid conductive elements 84, 86 can be different from the fluid conductive element 20.

Referring again to FIG. 9, once the connections of the first and second fluid conductive elements 84, 86 are made, the pump 18 is activated, thereby pumping water from the bladder cavity 48. The water is pumped through the second conductive element 86 to the pump 18, through the pump 18 to the first fluid conductive element 84, through the first fluid conductive element 84 to the water inlet port 82 and through the water inlet port 82 to the recreational vehicle holding tank (not shown).

Referring again to FIG. 9, once a desired volume of water is delivered to the recreational vehicle holding tank, the bladder 16, pump 18 and first and second fluid conductive elements 84, 86 are disassembled from each other and returned to the first and second compartments 22, 24 as described above and shown in FIG. 2. The bladder 16, pump 18 and first and second fluid conductive elements 84, 86 are stored in the first and second compartments 22, 24 as described above.

The filling system 10 provides many benefits, although all benefits may not be available in all embodiments. First, the system advantageously allows a refilling of the water holding tank within a conventional recreational vehicle with no movement of recreational vehicle. Second, the filling system 10 advantageously provides a source of potable water. Third, the filling system 10 advantageously provides refilling of the water holding tank of a conventional recreational vehicle without requiring access to the interior of the recreational vehicle. Fourth, the filling system 10 is readily and easily transportable from one location to another location. Finally, all of the components required to operate the filling system 10 are stored in a single protective container.

While the filling system 10 has been shown in FIGS. 1-9 and described above in the context of supplying water to a recreational vehicle, it is within the contemplation of the filling system 10 that other uses are possible. Non-Limiting examples of other uses include use by emergency first responders, use during natural disasters, and the like.

The principle and mode of operation of the filling system have been described in certain embodiments. However, it should be noted that the filling system may be practiced otherwise than as specifically illustrated and described without departing from its scope.

1. A portable water filling system for a recreational vehicle comprising;
a protective container having a first compailinent and a second compailinent, the first and second compailinents being rotatably connected to each other, each of the first and second compailinents forming interior cavities;
a first insulative element positioned in the first compailinent, the first insulative element having a first insulative cavity;
a second insulative element positioned in the second compailinent, the second insulative element having a second and third insulative cavity;
a pump positioned in the first and second insulative cavities;
a plurality of fluid conductive elements positioned with the pump in the first and second insulative cavities; and
a bladder having a volume capacity in a range of from about 20.0 gallons to about 40.0 gallons, the bladder having a folded arrangement to a size sufficient for insertion into the third insulative cavity;
wherein the first and second compailinents are configured for rotation from a closed orientation to an open orientation.

2. The portable water filling system for a recreational vehicle of claim 1, wherein the pump, the plurality of fluid conductive elements and the bladder are removed from the first and second compailinents for use.

3. The portable water filling system for a recreational vehicle of claim 1, wherein the system is configured to deliver water to a recreational vehicle without movement of the recreational vehicle.

4. The portable water filling system for a recreational vehicle of claim 1, wherein the water is potable water.

5. The portable water filling system for a recreational vehicle of claim 1, wherein a handle extends from the first compartment and is configured to facilitate ready movement of the system from one location to another.

6. The portable water filling system for a recreational vehicle of claim 1, wherein a plurality of fastening mechanisms extend from the first compailinent and are configured to engage corresponding structures on the second compartment in a manner such as to maintain the first and second compai linents in the closed arrangement.

7. The portable water filling system for a recreational vehicle of claim 1, wherein the bladder can have the folded arrangement, an unfilled arrangement, a partially-filled arrangement or an expanded or filled arrangement.

8. The portable water filling system for a recreational vehicle of claim 1, wherein the bladder is formed from a top panel connected to a bottom panel.

9. The portable water filling system for a recreational vehicle of claim 8, wherein the top panel is formed from an inner layer and an outer layer.

10. The portable water filling system for a recreational vehicle of claim 9, wherein the inner layer is configured to store potable water in compliance with NSF/ANSI 61 standard.

11. The portable water filling system for a recreational vehicle of claim 8, wherein the bottom panel is formed from an inner layer and an outer layer.

12. The portable water filling system for a recreational vehicle of claim 11, wherein the inner layer is configured to store potable water in compliance with NSF/ANSI 61 standard.

13. The portable water filling system for a recreational vehicle of claim 1, wherein the bladder is configured to receive a supply of water from a source of water and further configured to store the water received within a bladder cavity.

14. (canceled)

15. The portable water filling system for a recreational vehicle of claim 1, wherein the pump operates on 115 V.A.C.

16. The portable water filling system for a recreational vehicle of claim 1, wherein the pump operates to convey a volume of water from the bladder to a recreational vehicle holding tank.

17. The portable water filling system for a recreational vehicle of claim 1, wherein each of the plurality of fluid conductive elements include ends having a ¾-11.5NH threaded portions.

18. The portable water filling system for a recreational vehicle of claim 1, wherein one of the plurality of fluid conductive elements is configured for connection to a water inlet port of a recreational vehicle.
